(19) United States
(12) Patent Application Publication
(10) Pub. No.: US 2018/0214952 A1
(43) Pub. Date: Aug. 2, 2018

(54) USE OF FIBERS DURING HTHP SINTERING AND THEIR SUBSEQUENT ATTACHMENT TO SUBSTRATE

(71) Applicant: Halliburton Energy Services, Inc., Houston, TX (US)

(72) Inventor: Gagan Saini, The Woodlands, TX (US)

(21) Appl. No.: 15/748,470

(22) PCT Filed: Sep. 8, 2015
(86) PCT No.: PCT/US2015/048945

§ 371 Date: Jan. 29, 2018

(51) Int. Cl. B22F 3/15; B22F 7/02; C22C 47/06; B23P 15/28; B22F 3/00

(52) U.S. Cl. CPC B22F 3/15; B22F 7/02; C22C 26/00; B23P 15/28; B22F 3/002; C22C 47/068

(57) ABSTRACT

A fiber-reinforced cutting element for a drill bit and method of manufacturing same is disclosed. A plurality of fibers are formed in and embedded between the PCD table and the attached substrate. The fibers enhance the thermo-mechanical integrity of the cutting element as well as its wear and abrasion resistance and also help to minimize the failure of the bond between the PCD table and the substrate. The fibers may be coated with a ceramic material to help withstand the high temperatures during the HTHP sintering process used to form the PCD table. The PCD table is leached following the HTHP press cycle thereby partially exposing the fibers. The PCD table with partially exposed fibers is then bonded to a substrate through an infiltration, hot pressing or sintering process. A binder may optionally be used to enhance the binding of the substrate to the PCD table.

### TECHNICAL FIELD

The present disclosure relates generally to drilling tools, such as earth-boring drill bits, and more particularly to fiber reinforced diamond tables and methods of manufacturing the same.

### BACKGROUND

Various types of drilling tools including, but not limited to, rotary drill bits, reamers, core bits, and under reamers are used to form wellbores in downhole formations. Over the past several decades, there have been advances in the materials used to form drill bits. The cutting elements or cutters as they are sometimes called were once formed of natural diamond substances. Because of cost and other reasons, the industry sought alternative materials. In the mid-to-late 1970s, advances in synthetic diamond materials enabled the industry to replace natural diamond cutters with synthetic diamond cutters. The most common synthetic diamond that is used is a polycrystalline diamond material. These materials are formed into discs also known as compacts. Drill bits which use such synthetic diamond cutters are commonly referred to as polycrystalline diamond compact (PDC) bits.

The PDC cutters are typically formed by HTHP sintering of polycrystalline diamond powder with a substrate typically formed of a cemented tungsten carbide material where a sintering aid from the substrate melts and creates new diamond-to-diamond bonds. The PDC cutters are detached from tungsten carbide substrate (using EDM, laser cutting or other methods) and are sometimes leached to remove any sintering aids that may exist in the interstitial spaces so as to create a thermally stable polycrystalline (TSP) diamond prior to re-attachment to another substrate. The substrates on which the PCD tables are mounted are typically formed of a tungsten carbide material. The PCD tables are attached to the substrates using any one of a number of known methods. The completed PDC cutters are then mounted onto the blades formed on the drill bit body.

It is desired to improve the thermo-mechanical integrity of the cutting element as well as the wear and abrasion resistance of those elements and also to minimize the failure of the bond between the PCD table and the tungsten carbide substrate. Doing so will extend the life of the cutting elements which are a critical part of the drilling process.

### BRIEF DESCRIPTION OF THE DRAWINGS

For a more complete understanding of the present invention and its features and advantages, reference is now made to the following description, taken in conjunction with the accompanying drawings, in which:

FIG. 1 is a schematic diagram illustrating a fiber reinforced PCD cutter in accordance with the present disclosure;

FIG. 2 is schematic diagram illustrating the steps in forming the fiber reinforced PCD table in accordance with the present disclosure;

FIG. 3 is a schematic diagram illustrating the steps in bonding the substrate to the PCD table with the aid of the fibers in accordance with the present disclosure; and

FIGS. 4-8 are flow charts illustrating various exemplary alternative methods of forming a fiber reinforced PCD cutter in accordance with the present disclosure.

### DETAILED DESCRIPTION

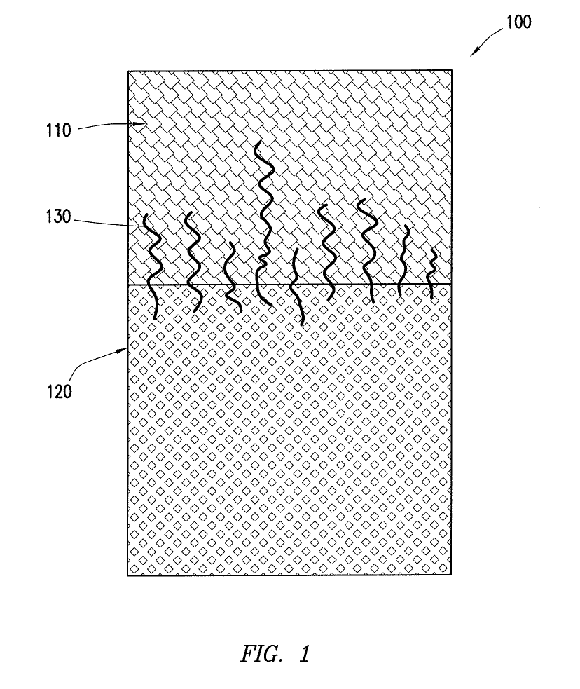

The present disclosure is directed to an improved PDC cutter referred to generally by reference numeral 100 shown in FIG. 1. The PDC cutter 100 is formed of a PCD table 110, which is attached to a substrate 120. The PCD table according to the present disclosure is formed of a thermally stable polycrystalline (TSP) diamond. The PCD table 110 is a full leached PCD disc made with metallic sintering aid as well as PCD disc made with non-metallic sintering aids (e.g., carbonates, of Mg, Ca, Ba, Sr, etc.). The substrate 120 is formed of cobalt-cemented tungsten carbide material or tungsten carbide infiltrated with other metals or alloy as binders. The PDC cutter 100 according to the present disclosure includes a plurality of fibers 130 which are embedded in and between the PCD table 110 and the substrate 120.

As used herein the term “fibers” is broadly defined to include fibers, whiskers, rods, wires, dog bones, ribbons, discs, wafers, flakes, rings, any combination thereof and similar members capable of reinforcing the structures of the PCD table 110 and substrate 120 and the bond formed there between said structures. These fibers may be microfibers, nanofibers, combinations thereof, or other suitable fibers. These fibers (depending on their composition) may or may not form a carbide bond with diamond (via the HTHP press cycle) and will also reinforce the surrounding material they are embedded in to resist crack initiation and propagation through the PCD table body.

In one exemplary embodiment, the composition of fibers may have a melting point greater than the sintering temperature during the HTHP (High Temperature/High Pressure) press cycle. Exemplary fiber materials/compositions include: Tungsten, Platinum, Chromium, Zirconium, Niobium, refractory ceramics (e.g., Zirconia-stabilized with Yttria (ZrO₂/Y₂/O₃), or Magnesia (ZrO₂/MgO), Silicon Carbide) and materials/compositions having similar properties as well as alloy thereof. The fibers may also be chemically resistant to common acids, such as those used during acid leaching (e.g., nitric acid, sulfuric acid, hydrochloric acid and any combination thereof). Such acids are typically used to leach metal sintering aids such as cobalt, iron, nickel and other similar sintering aids used to form the diamond-to-diamond bonds which create the PCD table during the sintering process.

One exemplary embodiment of the plurality of fibers 130 is a Tungsten (W) microfiber sold under the tradename Nicalon™, which has a melting point of approximately 3420° C., which is well above the approximate 1200-1800° C. temperatures typically experienced in a HTHP press cycle. Since Tungsten is generally known to be unaffected by most common acids, such fibers would remain intact during a typical leaching step. Another exemplary embodiment of the plurality of fibers 130 is a Silicon Carbide (SiC) fiber, which has a melting point approximately in the range of 2650-2950° C., which is also well above the typical temperatures experienced during a typical HTHP press cycle.

The plurality of fibers 130 may be localized to one side of the diamond powder during loading in the can or mold used in the HTHP press cycle. The fibers 130 can be further aligned or oriented in one direction if desired instead of random orientations. There are a number of different known techniques for orienting the fibers 130. One such technique is to expose the fibers to an electromagnetic field once they have been loaded into the mold. As those of ordinary skill in the art will appreciate, other magnetic and/or chemical orienting techniques may be employed to anchor fibers to the base of the mold, and then fill the molds with diamond powder mixed with metallic or non-metallic sintering aid. As a specific example, Platinum and Tungsten are paramagnetic and can be oriented using an external magnetic field. Such localization may, in some instances, provide mitigation for crack initiation and propagation while minimizing the additional cost that may be associated with some reinforcing fiber powders. The fibers could also be anchored or grown on different metallic discs (such metals would remain unaffected during HTHP sintering step, and dissolve during leaching step). These fibers could also be pre-oriented and pre-assembled on the base of the molds using various physical and chemical bonding techniques, e.g., adhesive bonding, brazing, soldering, etc.

The plurality of fibers 130 may also be coated with a ceramic or refractory material to increase their adhesion to the diamond during sintering and to enhance their chemical resistance to acids during leaching. The enhancement of the fibers 130 can also be improved by incorporation or doping of the sintering aid material in the fiber materials. In one exemplary embodiment, metallic wires may be coated with a ceramic layer so it readily forms tungsten carbide during the HTHP diamond sintering step. These coatings will remain unaffected during the acid leaching process in forming the PDC cutter and will act as anchoring regions for subsequent attachment to the intermediate material.

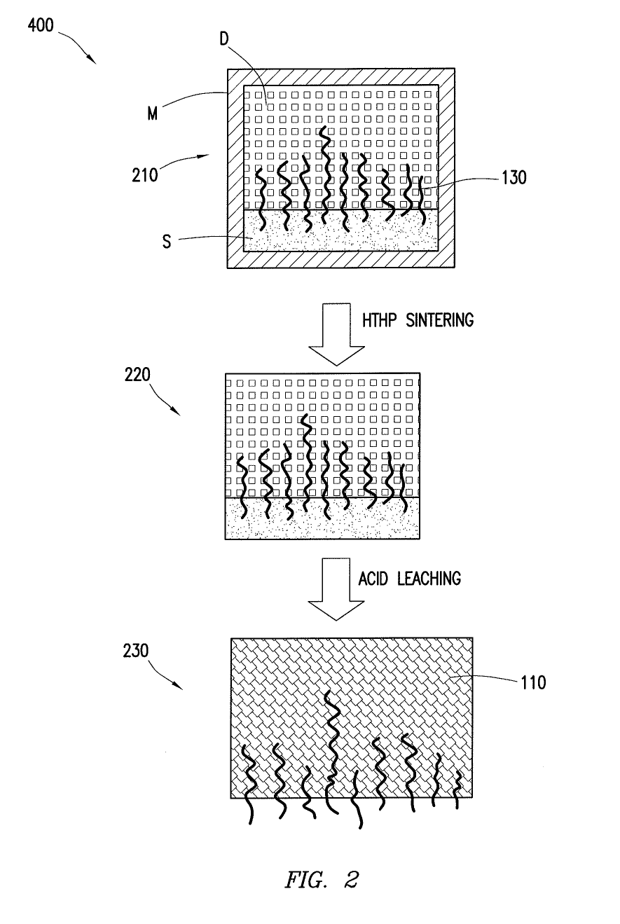

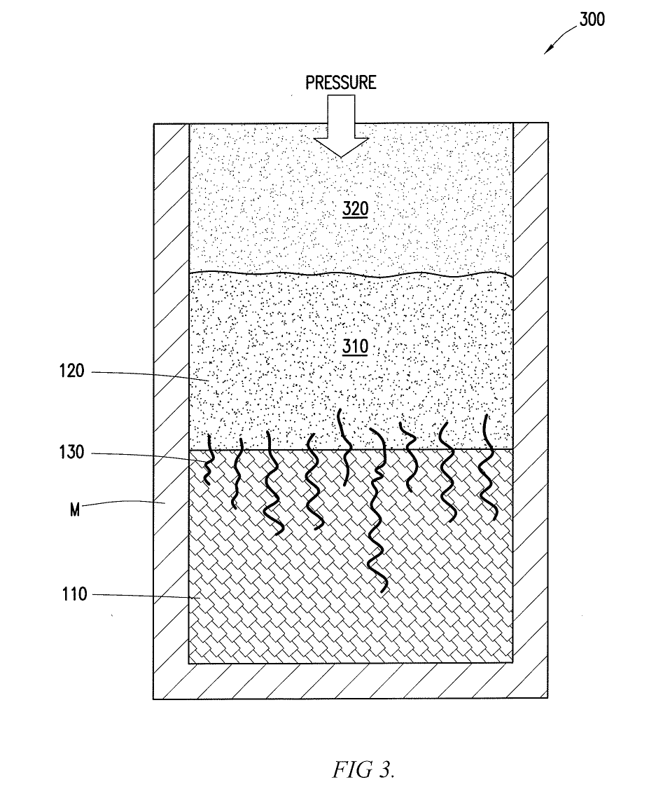

The method for forming the fiber-reinforced PDC cutters 100 will now be described with reference to FIGS. 2 and 3. The process is referred to generally by reference number 200. In the first step 210, a metal or non-metal sintering aid powder (S), for example Cobalt or Tungsten Carbide Cobalt mixture, is placed in the bottom of a mold (M). The mold M is preferably formed of Niobium or Zirconium. The plurality of fibers 130 are then placed in the mold M, preferably in a generally vertical orientation whereby they stick out of the sintering aid S. As noted above, there are a variety of methods for aligning the plurality of fibers 130 so that they have the desired orientation as well distribution. In step 210, the diamond powder (D) is placed in the mold M on top of the sintering aid S.

Once the sintering aid powder S, plurality of fibers 130 and diamond powder D are placed in the mold M, the mold M is placed in a HTHP press, which applies a pressure of approximately 6-10 GPa (gigapascals) at a temperature of approximately 1200-1800° C. The details of this HTHP diamond sintering step (step 220 in FIG. 2) are well known in the art and therefore will not be further described herein. The resultant disc comprises a polycrystalline diamond table sintered with cobalt, attached to a cobalt or cobalt-tungsten carbide sintered substrate imbedded with the plurality of fibers 130. The disc is then subjected to a dissolving step, which in the case of a metal sintering aid, includes a leaching step (step 230) during which any residual metallic sintering aids in the disc are removed. In one exemplary embodiment, the leaching step is carried out by submerging the disc in an acid bath, although, as those of ordinary skill in the art will appreciate, other methods of leaching may be used. In the acid bath, the cobalt or cobalt-tungsten carbide material is leached away, leaving a PCD table having a plurality of partially exposed fibers 130, as shown at the bottom of FIG. 2.

Turning the FIG. 3, the remaining steps 300 in forming the PDC cutter 100 are described. The PCD table 110 having partially exposed fibers 130 from step 230 in the process flow shown in FIG. 2 is placed in the mold M with the fibers 130 oriented upward. A tungsten carbide powder 310 used to form substrate 120 is placed adjacent the PCD table 110 in the mold. Furthermore, a binder 320 may optionally be placed on top of the tungsten carbide powder 310 as in typical infiltration process or binder 320 may be pre-mixed with tungsten carbide powder in required proportion. The substrate could also be formed in the way one makes cemented-carbide using standard or traditional powder metallurgy process. Typical binder materials could include copper, nickel, cobalt, iron, aluminum, molybdenum, chromium, manganese, tin, zinc, lead, silicon, tungsten, boron, phosphorous, gold, silver, palladium, indium, any mixture thereof, any alloy thereof, and any combination thereof. In one exemplary embodiment, the binder may be copper-manganese-nickel (Cu—Mn—Ni).

Once all of the components are placed into the mold M, the mold is placed into a furnace and the contents of the mold are placed under pressure using a press (not shown). After a predetermined amount of time for the liquefied binder material to infiltrate the matrix material, the mold M may be removed from the furnace and cooled at a controlled rate in a controlled atmosphere (mostly inert atmosphere created using argon, or vacuum). Once formed, the PDC cutters 100 can then be attached in sockets formed in the blades of the bit body (not shown) using torch brazing or other techniques.

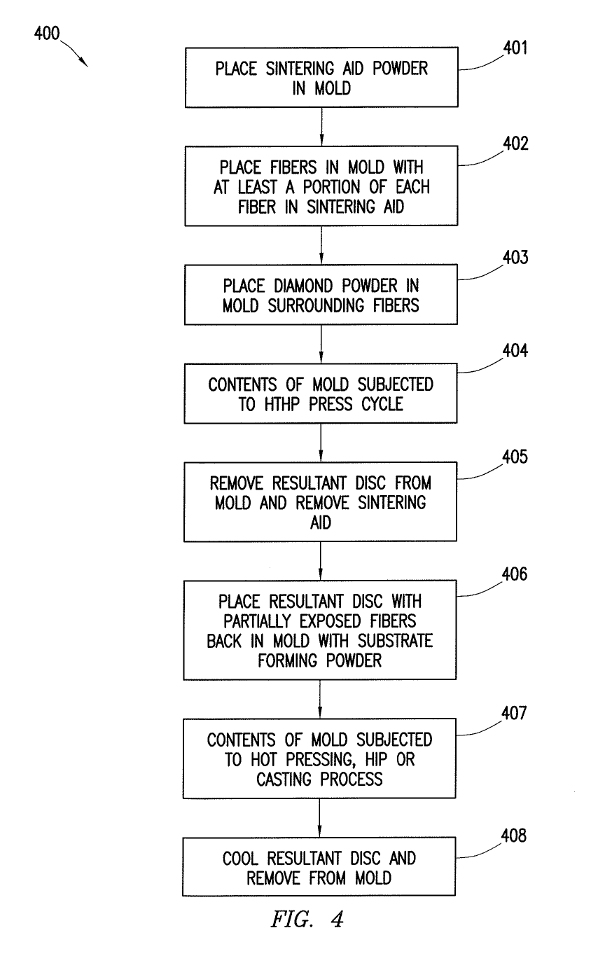

As those of ordinary skill in the art will appreciate there are various alternate ways to make the fiber reinforced PDC cutters in accordance with the present disclosure. Some of these additional methods will now be discussed with reference to FIGS. 4-8.

In one exemplary method 400, a sintering aid (in powder form) is placed in the mold M (box 401), as indicated in FIG. 4. Next, a plurality of fibers (in preferred orientation) is placed in the mold M with at least a portion of each fiber being disposed in the powder (box 402). Next, a diamond powder is placed in the mold M surrounding the fibers (box 403). The contents of the mold are then subjected to an HTHP press cycle (box 404). The sintering aid is then removed, e.g., by acid leaching (box 405) to form a thermally stable diamond. This results in the fibers being partially exposed on one face of the resultant disc. The resultant disc with fibers in placed in the mold with a substrate forming powder surrounding the fibers (box 406). The contents of the mold are then subjected to a hot pressing, hot isostatic pressing (HIP) or a casting process (box 407). The result fiber reinforced PDC cutter is then cooled and removed from the mold (box 408).

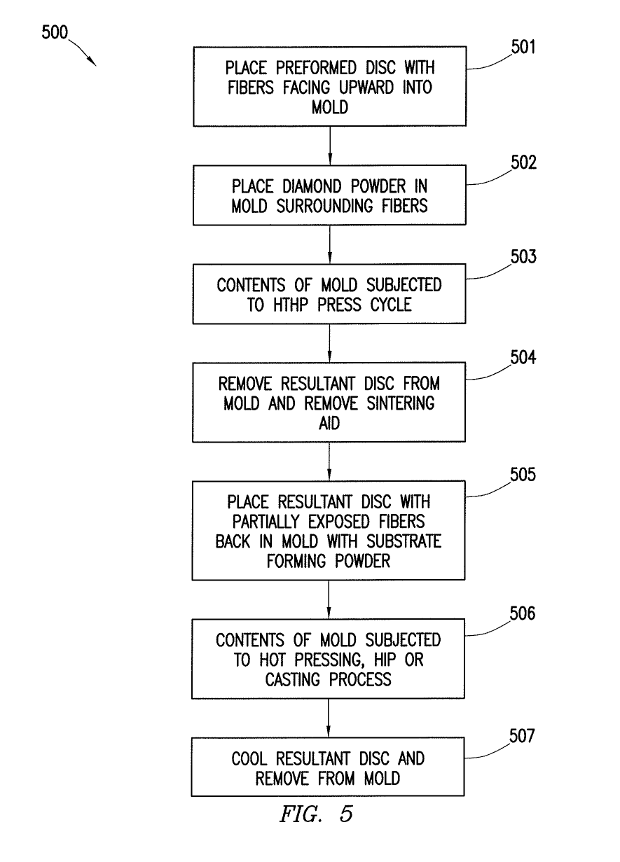

In another exemplary method 500, a preformed disc having fibers embedded therein in a preferred orientation is placed in the mold M with the fibers facing upward (box 501), as indicated in FIG. 5. Next, the diamond powder is placed in the mold surrounding the fibers (box 502). The contents of the mold are then subjected to an HTHP press cycle (box 503). The resultant disc is removed from the mold and then sintering aid is removed, e.g., by acid leaching the resultant disc (box 504) to form a thermally stable diamond. This results in the fibers being partially exposed on one face of the resultant disc. The resultant disc with fibers protruding outward is then placed back in the mold with a substrate forming powder surrounding the exposed fibers (box 505). The contents of the mold are then subjected to a hot pressing, hot isostatic pressing (HIP) or a casting process (box 506). The result fiber reinforced PDC cutter is then cooled and removed from the mold (box 507).

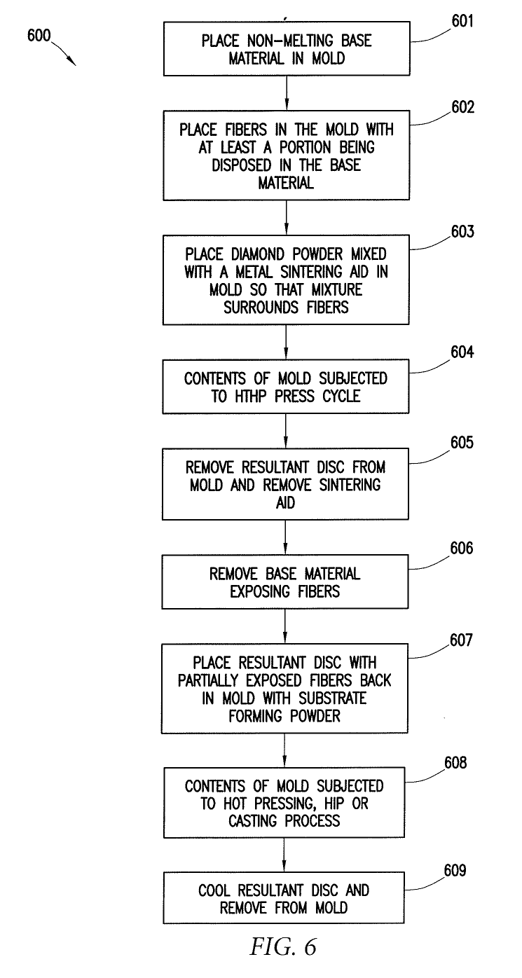

In yet another exemplary method 600, a base material, which may be a metal, alloy or composite material (in either powder or solid disc form), is placed in the mold M (box 601), as indicated in FIG. 6. The base material is selected such that it will not melt during an HTHP press cycle, i.e., the base material will have higher melting temperature than the peak HTHP press temperature. Next, a plurality of fibers is placed in the mold with at least a portion of each fiber being disposed in the base material (if it's in powder form) (box 602). Steps 601 and 602 may be combined if a preformed disc embedded with fibers is used as the starting material. Next, a diamond powder mixed with a metal sintering aid is placed in the mold M adjacent the base material (if, in powder form) with partially exposed fibers (or preformed disc with partially exposed fibers protruding outward), so that the diamond powder completely surrounds the partially exposed fibers (box 603). The contents of the mold are then subjected to an HTHP press cycle (box 604). The resultant disc is removed from the mold and then the sintering aid is removed, e.g., by acid leaching the disc (box 605) to form a thermally stable diamond. Next, the base material is removed which exposes the fibers embedded in the base material (box 606). The resultant disc with fibers is placed back in the mold with a substrate foiming powder surrounding the exposed fibers (607). The contents of the mold are then subjected to a hot pressing, hot isostatic pressing (HIP) or a casting process (box 608). The result fiber reinforced PDC cutter is then cooled and removed from the mold (box 609).

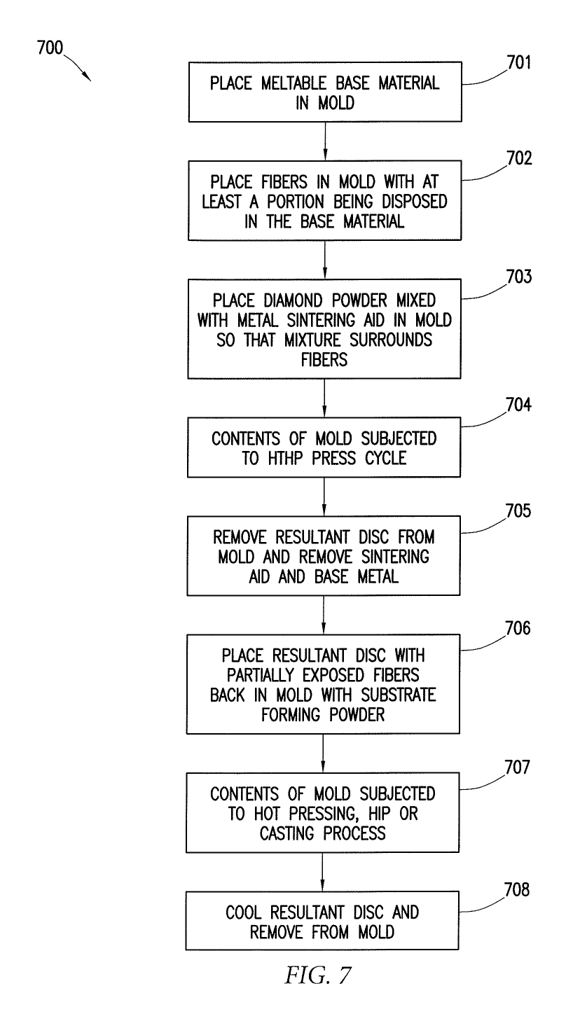

In yet another exemplary method 700, a base material, which may be a metal, alloy or composite material (in either powder or solid disc form), is placed in the mold M (box 701), as indicated in FIG. 7. The base material is selected such that it will melt during an HTHP press cycle. For example, the based material may be copper. Next, a plurality of fibers is placed in the mold with at least a portion of each fiber being disposed in the base material (if it's in powder form) (box 702). Steps 701 and 702 may be combined if a preformed disc embedded with fibers is used as the starting material. Next, a diamond powder mixed with a metal sintering aid is placed in the mold M adjacent the base material (if, in powder form) with partially exposed fibers (or preformed disc with partially exposed fibers sticking out), so that the diamond powder completely surrounds the partially exposed fibers (box 703). The contents of the mold are then subjected to an HTHP press cycle (box 704). The resultant disc is removed from the mold and then the sintering aid and base material are removed, e.g., by acid leaching the disc (box 705) to form a thermally stable diamond. It may also require different processes to remove the sintering aid and base material in some scenarios for optimal efficiency. The resultant disc has exposed fibers. It is placed back in the mold with a substrate forming powder surrounding the exposed fibers (box 706). The contents of the mold are then subjected a hot pressing, hot isostatic pressing (HIP) or a casting process (box 707). The result fiber reinforced PDC cutter is then cooled and removed from the mold (box 708).

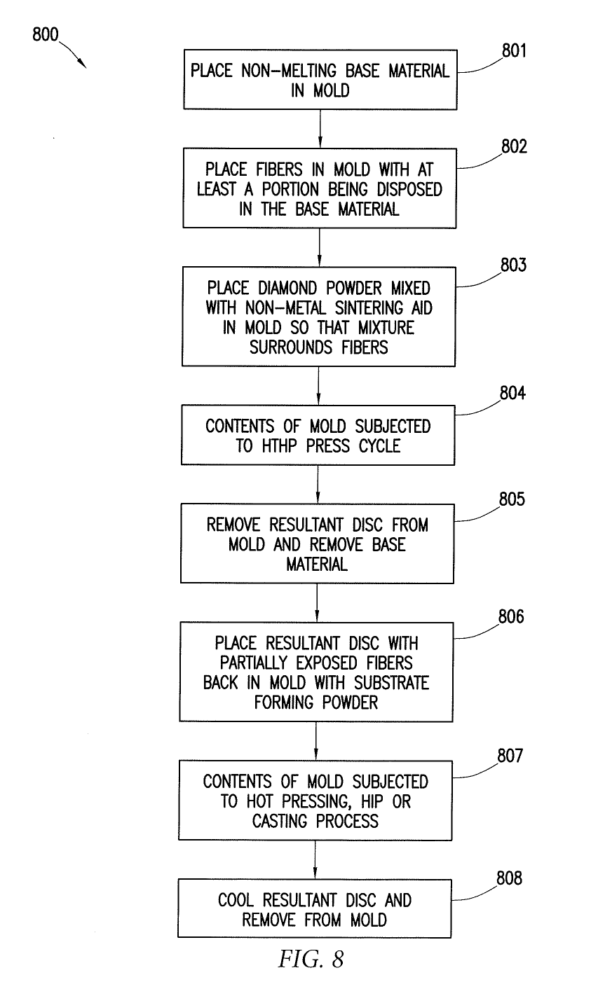

In yet another exemplary method 800, a base material, which may be a metal, alloy or composite material (in either powder or solid disc form), is placed in the mold M (box 801), as indicated in FIG. 8. The base material is selected such that it will not melt during an HTHP press cycle. Next, a plurality of fibers is placed in the mold with at least a portion of each fiber being disposed in the base material (if it's in powder form) (box 802). Steps 801 and 802 may be combined if a preformed disc embedded with fibers is used as the starting material. Next, a diamond powder mixed with a non-metal sintering aid is placed in the mold M adjacent the base material (if, in powder form) with partially exposed fibers (or preformed disc with partially exposed fibers sticking out), so that the diamond powder completely surrounds the partially exposed fibers (box 803). The contents of the mold are then subjected to an HTHP press cycle (box 804). The resultant disc is removed and then the base material is removed, e.g., using solvents, chemicals, electrolysis and other known techniques (box 805) to form a thermally stable diamond. The resultant disc has exposed fibers protruding outward. It is then placed in the mold with a substrate material in powder form surrounding the exposed fibers (806). The contents of the mold are then subjected to a hot pressing, hot isostatic pressing (HIP) or a casting process (box 807). The result fiber reinforced PDC cutter is then cooled and removed from the mold (box 808).

As those of ordinary skill in the art will appreciate, there one or more steps in the above-described exemplary methods may be combined and or modified to arrive at a thermally stable fiber reinforced PDC cutter in accordance with the present disclosure.

A polycrystalline diamond cutter for use in a drill bit, comprising a polycrystalline diamond table, a substrate attached to the polycrystalline diamond table, and a plurality of fibers, a portion of each fiber being embedded in the polycrystalline diamond table and a portion of each fiber being embedded in the substrate is disclosed. In any of the embodiments described in this paragraph, the plurality of fibers may be formed of microfibers, nanofibers, or combinations thereof. In any of the embodiments described in this paragraph, the plurality of fibers may be generally aligned in one direction and at the periphery of the polycrystalline diamond table. In any of the embodiments described in this paragraph, the plurality of fibers may be coated with a ceramic or refractory material. In any of the embodiments described in this paragraph, the plurality of fibers may be chemically resistant to acids. In any of the embodiments described in this paragraph, the plurality of fibers may be formed of Tungsten, Platinum, Chromium, Zirconium stabilized with Yttria (ZrO₂/Y2/O₃), Zirconium stabilized with Magnesia (ZrO₂/MgO), Silicon Carbide (SiC), and combinations thereof.

A method of forming a polycrystalline diamond cutter for use in a drill bit, comprising: placing a diamond powder in a mold; placing a plurality of fibers in the mold with at least a portion of each fiber being disposed in the diamond powder; and sintering the diamond powder so as to form a polycrystalline diamond table is disclosed. In any of the embodiments described in this paragraph, the method may further comprise: placing a substrate-forming powder in the mold adjacent the polycrystalline diamond table, with at least a portion of each of the plurality of fibers being disposed in the substrate-forming powder; and bonding the substrate to the polycrystalline diamond table.

In any of the embodiments described in this or the preceding paragraph, the substrate may be bonded to the polycrystalline diamond table via infiltration, hot pressing or sintering. In any of the embodiments described in this or the preceding paragraph, the method may further comprise adding a binder to the mold adjacent the substrate-forming powder. In any of the embodiments described in this or the preceding paragraph, adding the binder may comprise adding a material formed of cobalt, copper, nickel, cobalt, iron, aluminum, molybdenum, chromium, manganese, tin, zinc, lead, silicon, tungsten, boron, phosphorous, gold, silver, palladium, indium, and mixture thereof, any alloy thereof, and combinations thereof. In any of the embodiments described in this or the preceding paragraph, the plurality of fibers may be aligned by applying a magnetic field proximate to the fibers. In any of the embodiments described in this or the preceding paragraph, the method may further comprise aligning the plurality of fibers in one direction and at the periphery of the polycrystalline diamond table. In any of the embodiments described in this or the preceding paragraph, the method may further comprise coating the plurality of fibers with a ceramic or refractory material. In any of the embodiments described in this or the preceding paragraph, the method may further comprise forming the plurality of fibers of a material chemically resistant to acids. In any of the embodiments described in this or the preceding paragraph, the method may further comprise forming the plurality of fibers of microfibers, nanofibers or combinations thereof. In any of the embodiments described in this or the preceding paragraph, the method may further comprise forming the plurality of fibers of a material formed of Tungsten, Platinum, Chromium, Zirconium stabilized with Yttria (ZrO₂/Y2/O₃), Zirconium stabilized with Magnesia (ZrO₂/MgO), Silicon Carbide (SiC), and combinations thereof.

In any of the embodiments described in this or the preceding two paragraphs, sintering may comprise heating the mold to a temperature between approximately 1200° C. and 1800° C. and subjecting the mold to a pressure of approximately 6-10 GPa. In any of the embodiments described in this or the preceding two paragraphs, the method may further comprising mixing a metal-based sintering aid with the diamond powder placed in the mold, the sintering aid comprising a metal formed of a Group VIII element, and combinations and alloys thereof, or a non-metallic sintering aid formed of Ca, Mg, Ba, Sr, and combinations thereof. In any of the embodiments described in this or the preceding two paragraphs, the method may further comprise mixing a non-metal based sintering aid with the diamond powder placed in the mold.

Although the present disclosure and its advantages have been described in detail, it should be understood that various changes, substitutions and alterations can be made herein without departing from the spirit and scope of the disclosure as defined by the following claims. It is intended that the present disclosure encompasses such changes and modifications as fall within the scope of the appended claims.

What is claimed is:

1. A polycrystalline diamond cutter for use in a drill bit, comprising:
a polycrystalline diamond table;
a substrate attached to the polycrystalline diamond table; and
a plurality of fibers, a portion of each fiber being embedded in the polycrystalline diamond table and a portion of each fiber being embedded in the substrate.

2. The polycrystalline diamond cutter according to claim 1, wherein the plurality of fibers comprises fibers selected from the group consisting of microfibers, nanofibers, and combinations thereof.

3. The polycrystalline diamond cutter according to claim 1, wherein the plurality of fibers are generally aligned in one direction and at the periphery of the polycrystalline diamond table.

4. The polycrystalline diamond cutter according to claim 1, wherein the plurality of fibers are coated with a ceramic or refractory material.

5. The polycrystalline diamond cutter according to claim 1, wherein the plurality of fibers are chemically resistant to acids.

6. The polycrystalline diamond cutter according to claim 1, wherein the plurality of fibers are formed of a material selected from the group consisting of Tungsten, Platinum, Chromium, Zirconium stabilized with Yttria (ZrO₂/Y₂O₃), Zirconium stabilized with Magnesia (ZrO₂/MgO), Silicon Carbide (SiC), and combinations thereof.

7. A method of forming a polycrystalline diamond cutter for use in a drill bit, comprising:
placing a diamond powder in a mold;
placing a plurality of fibers in the mold with at least a portion of each fiber being disposed in the diamond powder; and
sintering the diamond powder so as to form a polycrystalline diamond table.

8. The method according to claim 7, further comprising:
placing a substrate-forming powder in the mold adjacent the polycrystalline diamond table, with at least a portion of each of the plurality of fibers being disposed in the substrate-forming powder; and
bonding the substrate to the polycrystalline diamond table.

9. The method according to claim 8, further comprising bonding the substrate to the polycrystalline diamond table via infiltration, hot pressing or sintering.

10. The method according to claim 8, further comprising adding a binder to the mold adjacent the substrate-forming powder.

11. The method according to claim 10, wherein adding the binder comprises adding a material selected from the group consisting of copper, nickel, cobalt, iron, aluminum, molybdenum, chromium, manganese, tin, zinc, lead, silicon, tungsten, boron, phosphorous, gold, silver, palladium, indium, and mixture thereof, any alloy thereof, and combinations thereof.

12. The method according to claim 7, wherein the plurality of fibers are aligned by applying a magnetic field proximate to the fibers.

13. The method according to claim 7, further comprising aligning the plurality of fibers in one direction and at the periphery of the polycrystalline diamond table.

14. The method according to claim 7, further comprising coating the plurality of fibers with a ceramic or refractory material.

15. The method according to claim 7, further comprising forming the plurality of fibers of a material chemically resistant to acids.

16. The method according to claim 7, further comprising forming the plurality of fibers of a material selected from the group consisting of microfibers, nanofibers and combinations thereof.

17. The method according to claim 7, further comprising forming the plurality of fibers of a material selected from the group consisting of Tungsten, Platinum, Chromium, Zirconium stabilized with Yttria (ZrO₂/Y2/O₃), Zirconium stabilized with Magnesia (ZrO₂/MgO), Silicon Carbide (SiC), and combinations thereof.

18. The method according to claim 7, wherein sintering comprises heating the mold to a temperature between approximately 1200° C. and 1800° C. and subjecting the mold to a pressure of approximately 6-10 GPa.

19. The method according to claim 7, further comprising mixing a metal-based sintering aid with the diamond powder placed in the mold, the sintering aid comprising a metal selected from the group consisting of a Group VIII element, and combinations and alloys thereof, or a non-metallic sintering aid selected from the group consisting of Ca, Mg, Ba, Sr, and combinations thereof.

20. The method according to claim 7, further comprising mixing a non-metal sintering aid with the diamond powder placed in the mold.
